(19) United States
(12) Patent Application Publication
(10) Pub. No.: US 2006/0138217 A1
(43) Pub. Date: Jun. 29, 2006

(54) Smart card handling system

(76) Inventors: Paul J. Connelly, Aurora (GB); Steve C. Painter, Ajax, CA (US); Kevin G. Quinn, Toronto, CA (US)

Correspondence Address: Ralph A. Dowell of DOWELL & DOWELL P.C., 2111 Eisenhower Ave, Suite 406, Alexandria, VA, 22314, US

(21) Appl. No.: 11/207,999

(22) Filed: Aug. 22, 2005

Related U.S. Application Data
(63) Continuation of application No. 10/429,240, filed on May 5, 2003, now abandoned.
Application No. 10/429,240 is a continuation of application No. 10/124,713, filed on Apr. 18, 2002, now abandoned.

(51) Int. Cl. G06K 5/00; G06K 7/06; G06K 13/00

(52) U.S. Cl. 235/380; 235/441; 235/475

(57) ABSTRACT

A smart card handling system is for handling a plurality of smart cards. It includes an infeed mechanism, a discharge mechanism, a rotary drum, an indexing mechanism, a motor and a control system. The rotary drum has a plurality of evenly spaced smart card read modules. The drum is mechanically connected to the infeed mechanism and the discharge mechanism. Each smart card read module is adapted to receive a smart card from the infeed mechanism and is adapted to read information from the smart card received therein. The discharge mechanism is adapted to receive smart card from the smart card read modules. The indexing mechanism is operably connected to the drum. The motor has a drive shaft mechanically connected to the indexing mechanism. The control system receives information from each of the plurality of read modules.

### CROSS REFERENCE TO RELATED APPLICATION

This application is a continuation application of U.S. patent application Ser. No. 10/429,240 which was filed on May 5, 2003, entitled SMART CARD HANDLING SYSTEM and which is being filed by the same inventors and which is a continuation of U.S. patent application Ser. No. 10/124,713 which was filed on Apr. 18, 2002, entitled SMART CARD HANDLING SYSTEM and which is being filed by the same inventors.

### FIELD OF THE INVENTION

This invention relates to smart card devices and more specifically smart card engines and systems using same.

### BACKGROUND OF THE INVENTION

Smart cards are well known and over the last decade the use of them has become increasingly popular. A smart card is a card with a silicon chip embedded therein. Smart cards are typically made from plastic like a credit card. The advantage of a smart card over a card having a magnetic stripe attached thereto is that the chip can hold considerably more information than a magnetic stripe. Another advantage of a smart card over a magnetic stripe is that large amounts of information may be both read from and written onto the chip many times using a compatible reader/writer.

Smart cards have a potentially very wide use. One current use of a smart card is as a phone card wherein the purchaser buys a predetermined amount of pre-paid phone time and each use of the phone card in a pay phone reduces the amount on the phone card by the price of the call. However, smart cards could be used as alternative to a credit card type card with a magnetic stripe since the smart card could easily hold more information than held on a magnetic stripe. Moreover, the smart card would have the added benefit that other types of functionality could be programmed into the card. Smart card are also being considered as a medium for personal identification such as drivers' licenses, health as well other security information.

Smart cards are typically manufactured at one location and then shipped to the bulk purchaser of smart cards. These cards may be preprogrammed with fixed information such as a predetermined amount of money in a phone card. Typically this initial shipping is of the cards in boxes or packs and does not include printed information that pertains to an individual. Accordingly a machine that the purchaser can use to verify the information would be useful. One such machine is shown in U.S. Pat. No. 5,322,989 issued to Long et al. on Jun. 21, 1994. This patent shows an on-the-fly smart card reader that includes at least one reader head that engages the smart card as it progresses along a conveyor system. Although this machine provides an automated system for verifying smart cards, the rate with which the cards can be processed is relatively limited and if that rate is increased by including multiple heads, so that multiple cards may be read simultaneously, the footprint of the system must be increased.

As the use of cards shifts from a single purpose where multiple cards have the same initial information to cards with individualized information, more sophisticated machines are required. Accordingly the manufacturing of the cards and the writing of the information may be separate from the manufacture of the cards. A number of elaborate systems have been suggested that are adapted to program information onto a smart card. Two such systems are U.S. Pat. No. 6,283,368 issued Sep. 4, 2001 to Ormerod et al. and U.S. Pat. No. 4,827,425 issued May 2, 1989 to Linden.

The Linden patent shows a smart card handling system that reads information from a magnetic stripe and then writes that information onto the smart card. Since varying amounts of information may be required to be written onto each chip the dwell time for each chip can vary. The infeed conveyor, the rotor and the outfeed conveyor are controlled independently and have separate motors so that the system can accommodate different dwell times. Accordingly, this system is complex and would be expensive to manufacture.

The Ormerod shows a smart card handling system that is designed to handle both contact and contactless smart cards. The infeed conveyor, the rotor and the outfeed conveyor each has a separate motor and a personal computer is used to control the motors and the interaction therebetween.

Accordingly it would be advantageous to provide a handling system that has high volumes and a fast rate of throughput. Further it would be advantageous for it to provide a handling system that can form part of a system that not only verifies information on the smart card but also prints personalized information to a letter, attaches the smart card to the letter and folds and stuffs the letter into an envelope.

### SUMMARY OF THE INVENTION

A smart card handling system is for handling a plurality of smart cards. It includes an infeed mechanism, a discharge mechanism, a rotary drum, an indexing mechanism, a motor and a control system. The rotary drum has a plurality of evenly spaced smart card read modules. The drum is mechanically connected to the infeed mechanism and the discharge mechanism. Each smart card read module is adapted to receive a smart card from the infeed mechanism and is adapted to read information from the smart card received therein. The discharge mechanism is adapted to receive smart card from the smart card read modules. The indexing mechanism is operably connected to the drum. The motor has a drive shaft mechanically connected to the indexing mechanism. The control system receives information from each of the plurality of read modules.

The smart card handling system is a rotary-indexing smart card writer/reader. It has a pick and place singulating device, which inserts cards into the path of an infeed conveying mechanism for transferring cards into smart card writer/reader modules, mounted on a rotary indexing drum. The rotary drum is equipped with a number of smart card writer/reader modules, which are evenly spaced around the circumference of the drum. After a card has been inserted into the card writer/reader module, the drum will index in a rotary motion, until the next writer/reader module is in position for receiving the next card. The writer/reader modules have contacts, and a clamp, which pivots down and forces the card into the contacts, just as the drum indexes to the next position. As the cards index around the drum the chip within the card is accessed, and a printed circuit board mounted to the rotary indexing drum, processes the information within each chip. During the time the cards are in contact with the writer/reader contacts, it may be possible to activate the write/read process more than once. Operational speeds of up to 10,000 cards per hour could be achieved with contact time ranging between 9 and 30 seconds. At a point further around the rotary path of the indexing drum, the cards are ejected out from the reader and into a discharge conveying mechanism for further processing. Along the path of the discharge conveyor are collection hoppers, which can be used to divert cards for certain functions designated by the control system.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a top view of the smart card handling system of the present system showing in detail the rotary indexing drum;

FIG. 2 is a top view of the smart card handling system similar to that shown in FIG. 1 but showing the infeed conveyor in detail;

FIG. 3 is a side view of the smart card reader module;

FIG. 4 is a flow chart of the control system for the smart card handling system of the present invention; and

FIG. 5 is a graph of the card to reader contact time versus the processing speed for the smart card handling system of the present invention.

### DETAILED DESCRIPTION OF THE INVENTION

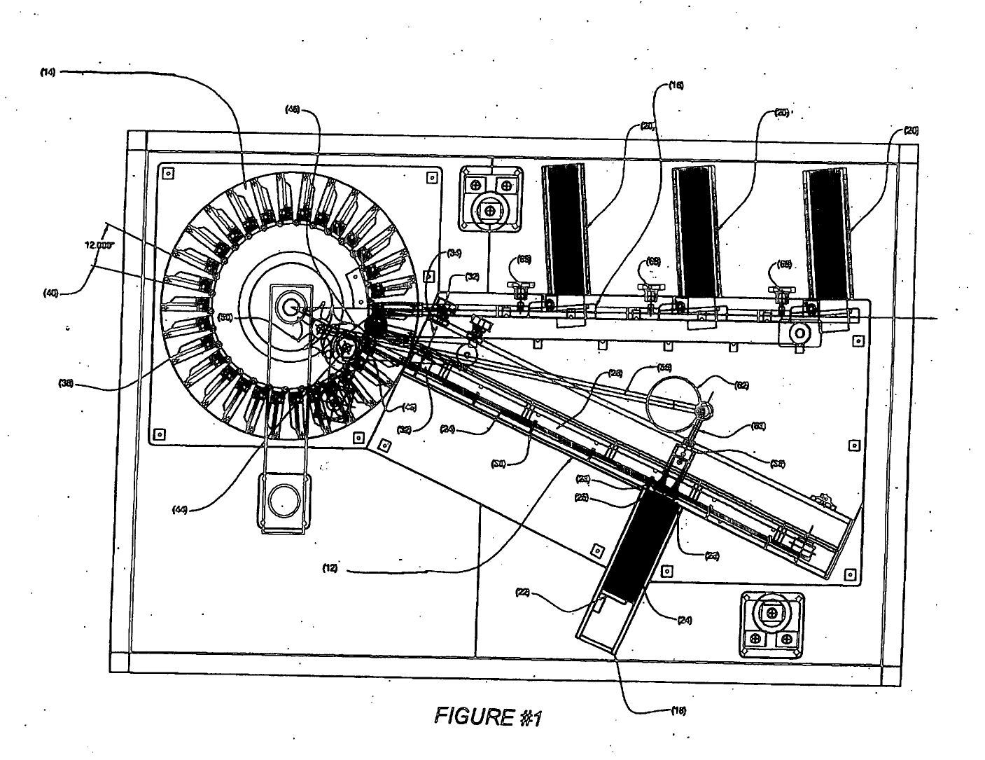

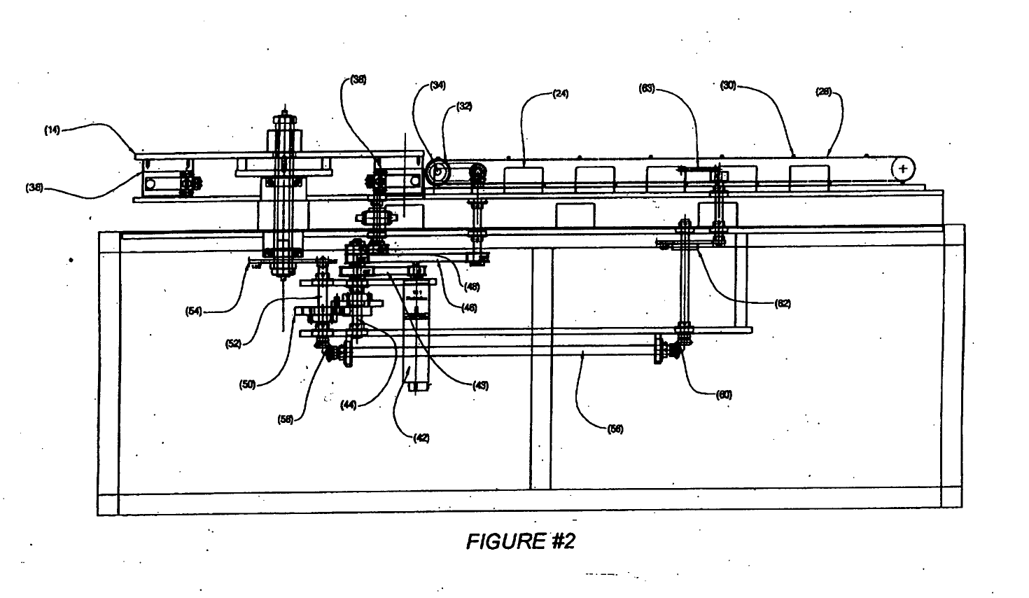

Referring to FIGS. 1 through 3, the smart card handling system of the present invention is shown generally at 10. The system includes an infeed conveyor 12, a rotary indexing drum 14 and a card discharge conveyor 16. It also includes a card loading hopper 18 and card collection hoppers 20 both shown in FIG. 1.

Referring to FIG. 1, the card loading hopper 18 is a flat conveyor with a weighted rear pusher 22 that applies pressure to the back of the smart cards 24. The pusher 22 pushes the cards 24 up against an end stop 26 as a card is extracted by means of an air-operated shuttle plate 25 which shears the leading card away from the stack of cards. The rear pusher moves the cards to fill the gap created by the vacant card.

The card infeed conveyor 12 consists of a timing belt 28. Preferably an endless 5 mm pitch timing belt. On the back of the timing belt 28 are push pins 30 located every 160 mm apart (32 teeth) around the circumference of the belt 28. The conveyor is driven by a 32 tooth-timing pulley 32. Infeed conveyor drive shaft 34 is driven by 1:1 belt drive 37, which is driven via one set of bevel gears 41. The vertical shaft holding the bevel gears is driven by belt 46. Thereby one revolution of the infeed conveyor drive shaft 34 moves the belt 28 and card 24 one pitch or 160 mm.

Adjacent to the card loading hopper 18 on the card infeed conveyor 12 is a pick and place unit 36. The pick and place unit 36 uses vacuum cups 26 to extract the smart cards 24 from the end of the card loading hopper 18. Pick and place unit 36 is operably connected to and driven by the rotary indexing drum 14. The cards are fed along the infeed conveyor 12 such that generally only their edges are touched. This is advantageous since it reduces the likelihood of the handling system marring the surface coating on the card.

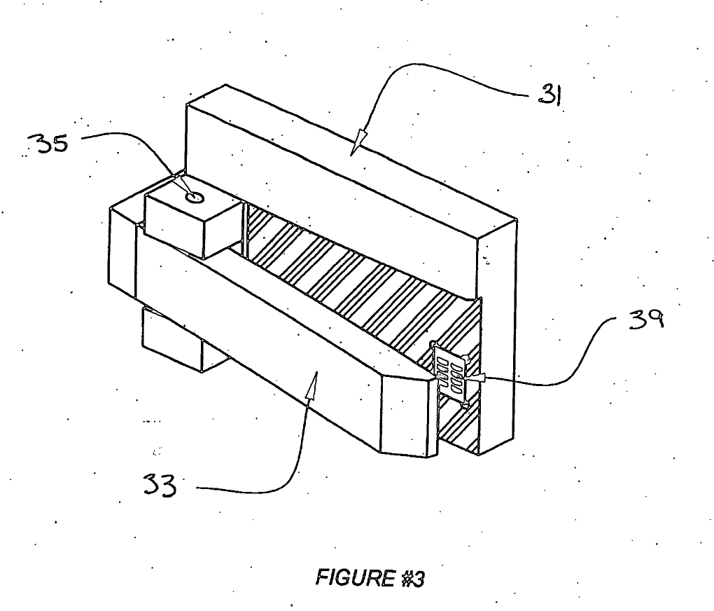

The rotary indexing drum 14 consists of plurality of read modules 38. Preferably 30 read modules 38 are evenly spaced around the outer circumference of the drum 14. Thereby the modules 38 are spaced 12 degrees apart as shown at 40. For contact type smart cards 24, the reader modules 38 have contacts, which preferably are cam operated and which pivot down and land on the chip pads when the card is fully in position. An example of a reader module 38 is shown in FIG. 3. The reader module includes a reader housing 31 and a pivoting clamp arm 33 which is pivotally attached to the reader housing 31 by pivot pin 35. Reader module contacts 39 are attached to the reader housing 31 such that when the smart card is positioned therein information on the smart card chip may be accessed. As a card indexes around the drum 14 the chip within the card is accessed and a printed circuit board mounted to the rotary indexing drum 14, processes the information within each chip.

The drum 14 is driven by the main servomotor 42 and gearbox through a timing belt 43 reduction to a main drive shaft 44. As a cards index around the drum 14 the chip within the smart card 24 is accessed and a printed circuit board mounted to the rotary indexing drum 14 accesses the information within each chip and forwards it to the control system.

The drive shaft 44 is set to rotate exactly one revolution for every pitch of the system. The drive shaft 44 there is operably connected to the infeed conveyor 12 by belt drive 46. Similarly drive shaft 44 is operably connected to the card discharge conveyor 16 by belt 48. This maintains the timing between the infeed conveyor 12, the discharge conveyor 16 and the rotary indexing drum 14.

A Geneva mechanism 50 is operably connected to the drive shaft 44. The Geneva mechanism has a 5-point driven wheel. This means that for every rotation (360 degrees) of the drive shaft 44 the driven shaft 52 rotates one fifth of a revolution (72 degrees).

One end of the driven shaft 52 meshes gear 54 in a 6:1 ratio. Driven shaft has 24 teeth and it meshes with a 144 tooth gear 54, thereby reducing the angular rotation to 12 degrees which is the spacing of each of the read heads on the rotary indexing drum 14.

The indexing action of the 5 point Geneva mechanism 50 is one fifth of the input drive, thereby the rotary indexing drum 14 will dwell for 80% (128) mm of the infeed conveyor 12 motion and index for 20% (32 mm) of the infeed conveyor motion.

Drive shaft 44 is operably connected to the pick and place unit 36. The lower end of drive shaft 44 is coupled a cross shaft 56, by means of two sets of bevel gears 58,60 which transmits indexing rotation motion to the pick and place head 36 via 5:1 gear ratio 62. Thereby the 72 degree rotation is multiplied by 5 to give 360 degree rotational motion. This motion drives a rotary crank arm 63 of the pick and place unit 36 one revolution. This rotary motion is changed to linear motion through the crank arm 62 which extends and retracts the pick and place head 36 for 20% of every infeed conveyor pitch.

The discharge conveyor 16 is spaced below the rotary indexing drum 14. Once the smart cards 24 have indexed around 336 degrees, the cards 24 are dropped into a path of the card discharge conveyor. The discharge conveyor has a similar timing belt to the infeed conveyor, with pusher pins located every 160 mm around the circumference of the belt. The discharge conveyor is driven by a 32 tooth timing pulley. Thereby, one revolution of the discharge conveyor drive shaft moves the belt and card one pitch, or 160 mm.

The discharge conveyor 16 is belt driven from the drive shaft 44 similar to that with the infeed conveyor 12. The smart cards 24 may be dropped onto the conveyor in a number of different orientations. The user can pick the most useful orientation for the handling of the card downstream. For example the card could be face down, upright (as with the infeed) or face up.

Collection hoppers 20 are spaced along the length of the card discharge conveyor. For certain applications a plurality of collection hoppers 20 will be used and each hopper 20 is for receiving cards having predetermined characteristics. For example the collection hopper 20 may simply collect rejected cards. On the other hand the collection hopper may only collect cards with defective smart chips whereas other hoppers may collect cards with functioning chips but with incorrect information written onto the chip. Each hopper 20 has a pneumatically operated valve 68 which will divert the card into the desired hopper as instructed by the systems computer.

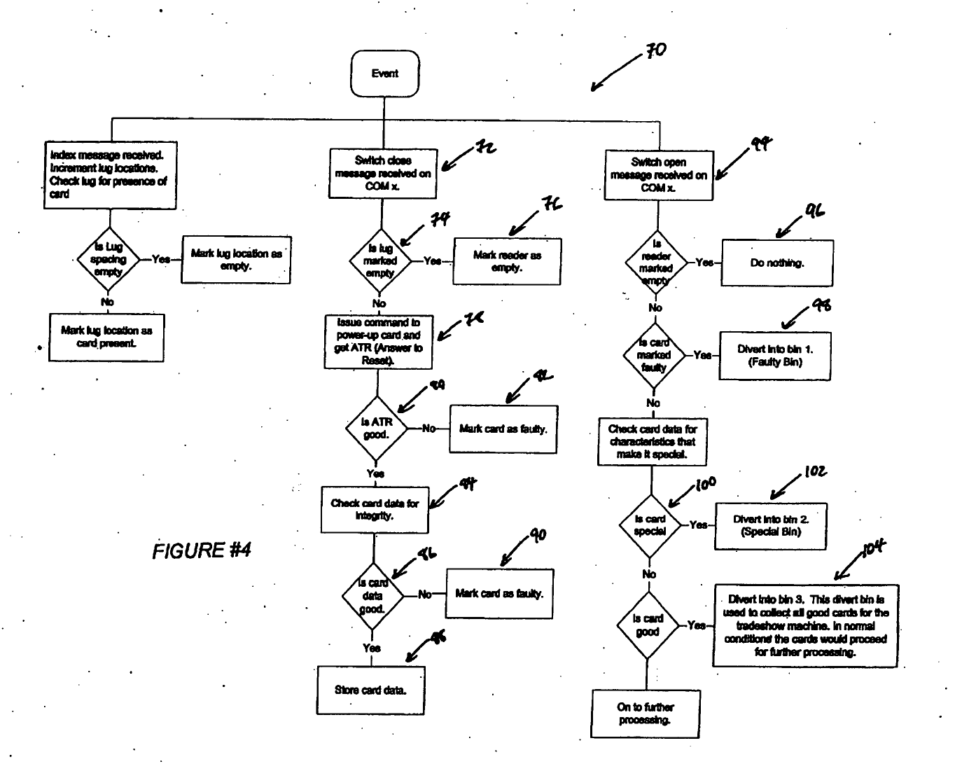

A flow chart of the control system for the smart card system 10 of the present invention is shown generally at 70 in FIG. 4. As a new card is inserted into a reader module and the switch is closed, the reader module sends a message 72 to the computer stating that a card has been inserted. Then it is determined if the lug is marked is empty 74. If empty the reader is marked as empty 76. A command is issued, when the card is present, to power up the inserted smart card 78. If an answer to reset (ATR) is received then the chip is good 80 and if not the card is marked as defective 82. The system also checks the ATR to verify that the correct type of smart card has been inserted into the reader module. If the ATR is correct, the system then issues another command to read a block of data that will be used to verify that the data on the card is of the correct format or to check the integrity of the card 84. If the data on the card is in the correct format, the system then issues commands to read relevant data on the card 86. If the data is good it is stored 88 and if not the card is marked as faulty 90. When the system is done with the card in the reader module, it issues a command to power-down the card when data from the chip has been gathered. Finally when the switch is opened 94, the reader module sends a status message to the system stating that the card has been removed.

When the switch is opened 94 the card is dropped onto the card discharge conveyor 16 and the cards are sorted. If the reader is marked empty nothing is done 96. If the card is marked to be diverted, it is diverted into a hopper 98 or continues on for additional processes. Since the card data has been stored 88 that data may be reviewed to determine if certain information is present thereby marking the card special 100 and diverting it into a special hopper 102. The remaining cards are good and sent along the discharge conveyor to the next station or into a good hopper 104.

The smart card handling system control system of the present invention is preferably based on the Windows™ event-driven programming model. Accordingly, program flow is determined upon events received in the applications message queue. The application retrieves the messages and passes them to their appropriate message handlers. Events can be generated through user interaction by means of the mouse, keyboard or touch screen and can also be generated by receiving incoming data through a serial or hardware port. The smart card control system communicates to the smart card reader modules 38 through the serial port by means of events. Therefore the control system does not need to poll the serial port for new data using needless CPU overhead. The control system interfaces with the reader modules 38 using a class object named ‘SCReader’ (Smart Card Reader) which encapsulates the BCS (basic command set), present in some readers—such as ACS, into methods. These interfaces allow the control system to have full control of the reader module 38 and a smart card 24 inserted in the reader module. The serial communication is all done through overlapped 10 (multitasking ) allowing the control system to seamlessly communicate to many reader modules 38 at the same time. Accordingly the smart card handling system of the present invention can be retrieving information from one reader module and also be sending a command to another.

It will be appreciated by those skilled in the art that the choice of the number of read modules can be varied by the user but all the ratios would have to be adjusted accordingly.

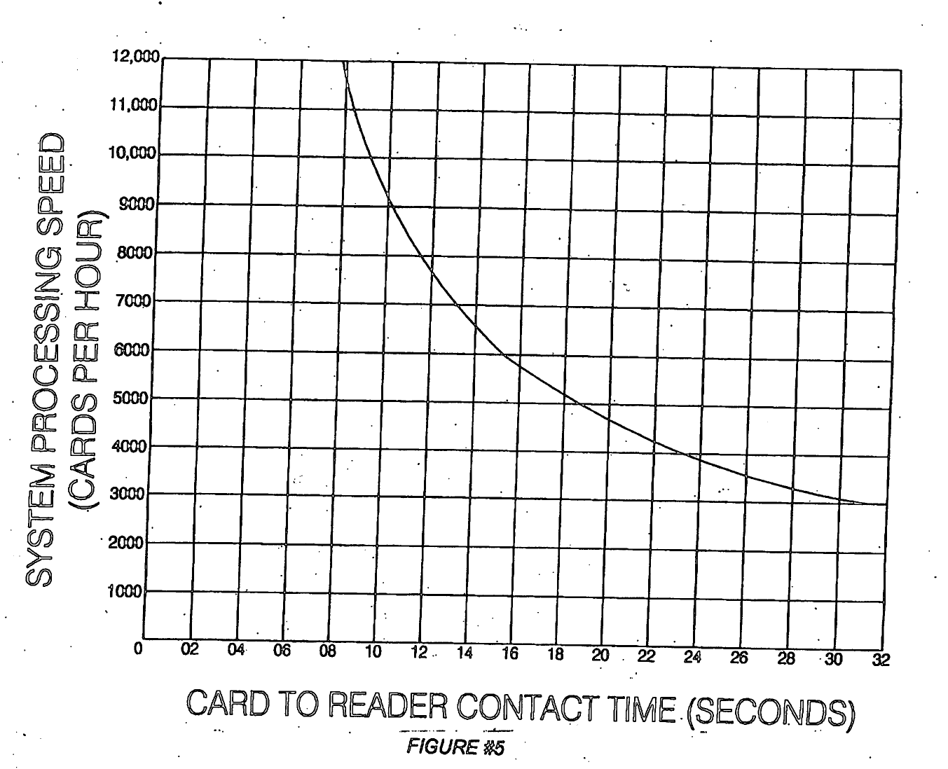

Referring to FIG. 5, operation speeds of 4,000 to 10,000 cards per hour could be achieved with contact time ranging between 24 and 9 seconds respectively. During the time the cards are operably connected to the reader contacts, it may be possible to activate the write/read process more than once depending on the available time.

Further it will be appreciated by those skilled in the art that the read module could be substituted with a read/write module depending on the applications required by the user. This of course would add complexity to the control system but the control system is easily adaptable to such an addition.

There are a number of advantages that are realized by the smart card handling system of the present invention. As discussed above since the infeed conveyor generally handles the cards by its edge the chance of marring the coating on the card or scratching the chip is reduced. Since the infeed conveyor, the rotor and the outfeed conveyor are mechanically linked only one motor need be used, thus reducing the cost and making the system easier to control. Further, the system is designed to work at high speeds, with extended contact (read) time, which allows the user to verify a large number of cards over a relatively short period of time. Further the smart card handling system can be adapted to include other functions such as vision inspection, activation labelling and printing, folding and mailing inserts. As discussed above, the smart card may have a variety of different orientations on the discharge conveyor 16 and the orientation would be dependent on the processing or modules down stream. Typically, if the smart card is to be added to printed material which is then folded and addressed it is most advantageous for the card to be face up on the discharge conveyor 16.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

What is claimed as the invention is:

1. A smart card handling system for handling a plurality of smart cards comprising:
an infeed mechanism;
a discharge mechanism;
a rotary drum having a plurality of evenly spaced smart card read modules and being mechanically connected to the infeed mechanism and mechanically connected to the discharge mechanism, each smart card read module being adapted to receive a smart card from the infeed mechanism and adapted to read information from the smart card received therein and whereby the discharge mechanism is adapted to receive smart card from the smart card read modules;
an indexing mechanism operably connected to the drum;
a motor having a drive shaft mechanically connected to the indexing mechanism; and
a control system for receiving information from each of the plurality of read modules.

2. A smart card handling system as claimed in claim 1 further including at least one collection hopper adjacent to the discharge mechanism and wherein the control system further includes a means for identifying smart cards having predetermined characteristics and the hopper is adapted to receive identified smart cards.

3. A smart card handling system as claimed in claim 2 wherein the infeed mechanism is an infeed conveyor system connected to the drive shaft by a drive belt

4. A smart card handling system as claimed in claim 3 wherein the discharge mechanism is a discharge conveyor system connected to the drive shaft by a drive belt.

5. A smart card handling system as claimed in claim 4 further including a card holding hopper for holding a plurality of smart cards and a means for moving a smart card from the card holding hopper to the infeed conveyor

6. A smart card handling system as claimed in claim 5 wherein the moving means is a pick and place unit operably connected to the drive shaft.

7. A smart card handling system as claimed in claim 6 further including a plurality of exit hoppers wherein each hopper has definable predetermined characteristic on the smart card to be received therein.

8. A smart card handling system as claimed in claim 7 wherein there are at least thirty read modules.

9. A smart card handling system as claimed in claim 8 wherein the indexing mechanism is a Geneva mechanism.

10. A smart card handling system as claimed in claim 8 wherein the read modules are read/write modules and the control system is adapted to write data onto the smart cards.

11. A smart card handling system as claimed in claim 2 further including a plurality of hoppers wherein each hopper has definable predetermined characteristic on the smart card to be received therein.

12. A smart card handling system as claimed in claim 1 wherein there are 30 read modules.

13. A smart card handling system as claimed in claim 1 wherein the indexing mechanism is a Geneva mechanism.

14. A smart card handling system as claimed in claim 1 wherein the read modules are read/write modules and the control system is adapted to write data onto the smart cards.
